(19) United States
(12) Patent Application Publication
(10) Pub. No.: US 2012/0167741 A1
(43) Pub. Date: Jul. 5, 2012

(54) HEDGE TRIMMER AND A BLADE THEREFOR

(75) Inventors: Colin Duffy, Shutford (GB); Martin Lugert, Gunzburg (DE)

(73) Assignee: Gardena Manufacturing GmbH, Ulm (DE)

(21) Appl. No.: 13/395,162

(22) PCT Filed: Sep. 9, 2009
(86) PCT No.: PCT/EP2009/006524

§ 371 Date: Mar. 9, 2012

(51) Int. Cl. B26D 1/00

(52) U.S. Cl. 83/697

(57) ABSTRACT

A blade for a hedge trimmer comprises a plurality of cutting teeth, each tooth having a longitudinal axis extending laterally away from the long axis of the blade, each cutting tooth comprising a root and a tip and opposing sides extending between the root and the tip, characterised in that at least one of the cutting teeth comprises a special tooth which is sharpened along at least one flank to form a cutting edge which extends to the free end of the tooth, and further in which the free end of the special tooth includes a connecting edge which extends from one flank of the tooth to the other and at least one part of which is inclined at an angle of between 4 degrees and 20 degrees relative to the long axis of the blade.

This invention relates to a cutting blade for a hedge trimmer, and to hedge trimmers which include a cutting blade.

Hedge trimmers of known kind comprise at least one movable blade and a second blade which may be fixed in a single action type trimmer or may also move in a double action type trimmer. The blades each comprise laterally protruding teeth arranged at spaced intervals along the length of the blade. In use the blades move to and fro relative to one another along their long axes in a reciprocating manner. This motion causes the teeth of the respective blades to move towards and away from each other in a scissor type action, to open and close branch receiving spaces between adjacent teeth. Any branches entering such a space when open will be cut as the teeth move together closing the space.

It is known to provide a blade for a hedge trimmer of the aforementioned kind which has a plurality of symmetrical teeth on the first blade whose sharpened flanks are slanted uniformly from the root to the tip of the tooth, e.g. the flanks are inclined at some small angle away from an imaginary line that extends perpendicular to the long axis of the blade. This incline of the tooth edge allows fine branches to reach the bottom of the space between teeth, whilst coarser branches can only extend part way into the space.

It is also known that the teeth of the second blade may be extended a greater distance laterally than the teeth of the first blade to form blunt extensions or guards which take no part in a cutting action with the teeth of the other blade but help to ensure oversized branches are kept away from the cutting edges and at the same time offer an additional protective feature to the user.

According to a first aspect the invention provides a blade for a hedge trimmer comprising a plurality of cutting teeth, each tooth having a longitudinal axis extending laterally away from the long axis of the blade, each cutting tooth comprising a root and a tip and opposing sides extending between the root and the tip, characterised in that at least one of the cutting teeth comprises a special tooth which is sharpened along at least one flank to form a cutting edge which extends to the free end of the tooth, and further in which the tip of the tooth includes a connecting edge which extends from one flank of the tooth to the other and at least one part of which is inclined at an angle of between 4 degrees and 20 degrees relative to the long axis of the blade.

Preferably the special tooth is sharpened on both flanks to form respective cutting edges which extend to the tip of the tooth and the connecting edge is inclined from one flank to the other flank.

Sharpening the one flank right to the tip and inclining the connecting edge provides a sharpened corner which in use provides a scissor like sawing action on any large diameter branches against which the tooth is placed as it reciprocates in use in a hedge trimmer. This helps cut through any branches which are too large in diameter to fit into the spacing between the teeth.

The connecting edge portion may be so shaped as to be concave and may define a v-shaped or U-shaped connecting edge, with a first edge portion inclined at an angle of between 4 degrees and 20 degrees relative to the long axis of the blade and extending from one flank of the tooth towards the centre line of the tooth, and a second edge portion extending from the other flank of the tooth towards the centre line of the tooth which is oppositely inclined at an angle of between 4 degrees and 20 degrees relative to the long axis of the blade.

The blade may include a plurality of special teeth which may be located at spaced locations along a length of the blade which, in use, is furthest from the handle of the hedge trimmer. Closer to the handle teeth may be provided which are not sharpened right to the end and, or, which do not have inclined connecting end portions. These teeth may also be longer than the special teeth to provide a guard region.

There may be at least one, or two, and preferably four longer teeth located at spaced locations between the special teeth and the handle, each of which is not a special tooth.

There may be at least four, and preferably at least eight special teeth.

The teeth of the blade may be spaced at regular intervals along the blade length.

The blade may include two rows of teeth, one row on each edge of the blade.

In a preferred arrangement the special tooth may narrow in width (i.e. from flank to flank) from its root toward its free end, and the cutting edge on each flank may be beveled so that it tapers inwards at a greater angle towards the tip than it does over a mid portion. The sharpened edges of the flanks may be inclined where they reach the free end so that sharpened edge and connecting edge meet at the pointed corner at an obtuse angle. An obtuse angle may be defined for the intersection on both flanks of the tooth.

The special teeth may be provided on one long edge only of the blade, or on both long edges of the blade.

The connecting edge most preferably is inclined at an angle of 5 degrees.

According to a second aspect the invention provides a hedge trimmer comprising at least two blades, a first blade of which is in accordance with the first aspect of the invention and a second blade, in which the second blade also comprises a plurality of cutting teeth which co-operate with the teeth of the first blade to provide a cutting action as the blades reciprocate relative to one another, each tooth having a longitudinal axis extending laterally away from the long axis of the blade, each cutting tooth comprising a root and a tip and opposing flanks extending between the root and the tip, and in which at least one of the teeth of the second blade is longer from root to tip than a corresponding tooth of the first blade and is blunt along both flanks towards its free end, and at least one of the teeth of the second blade comprises a special tooth being of substantially the same length as the corresponding special tooth of the first blade.

The longer teeth of the second blade may be at least 30 percent longer, or 50 percent longer, than the corresponding teeth of the first blade.

The extensions of the second blade having blunt flanks function as guard portions, preventing accidental contact between the corresponding teeth of the first blade and any branch or other body which has a diameter that exceed the spacing between adjacent teeth on the blades. Where special teeth of the same length are provided on both the first and second blades a scissor like cutting action is achieved when the blade contacts large branches and the like.

The first blade may be arranged to reciprocate along its long axis relative to the second blade which may be fixed. Alternatively both the first and second blades may be arranged to reciprocate relative to one another to provide a dual cutting action.

The at least one tooth of the second blade which is substantially the same length as the or each corresponding tooth on the first blade may comprise a special tooth which is sharpened along at least one side to form a cutting edge which extends to the free end of the tooth, and further in which the free end of the tooth comprises an edge portion which is inclined at an angle of between 4 degrees and 20 degrees extending from one side edge of the tooth towards its central axis, and most preferably at an angle of 5 degrees.

By providing special teeth with cutting edges up to the free ends on both the first and second blades a highly effective cutting action can be achieved which enables the tips to saw through branches of large diameter.

The connecting end of a special tooth on the first blade may be inclined in an opposed direction to the direction of inclination of the connecting edge of a corresponding tooth of the second blade. For example, if the connecting edge of the special tooth of the first blade is inclined at and angle of, say, 5 degrees sloping from left to right, the connecting edge of the special tooth may be inclined at an angle of, say, 5 degrees, sloping from right to left.

According to a third aspect the invention provides a hedge trimmer comprising a first blade and a second blade, in which the first blade comprises a set of teeth of a first length arranged at spaced locations along the blade, and a second blade which overlaps the first blade and which includes a first set of teeth substantially of the same first length as the corresponding teeth of the first blade, and a second set of teeth of longer length which provide guard portions to the corresponding teeth of the first blade, the second set of teeth comprising teeth closer to the handle of the hedge trimmer than the first set of teeth which have blunt free ends and the first set of teeth being sharpened on at least one flank up to the free end.

The first set of teeth of the second blade may be sharpened on both flanks right to the free end, as may the corresponding teeth of the first blade.

There now follows, by way of example only, embodiments of the invention, described with reference to the accompanying drawings, in which:

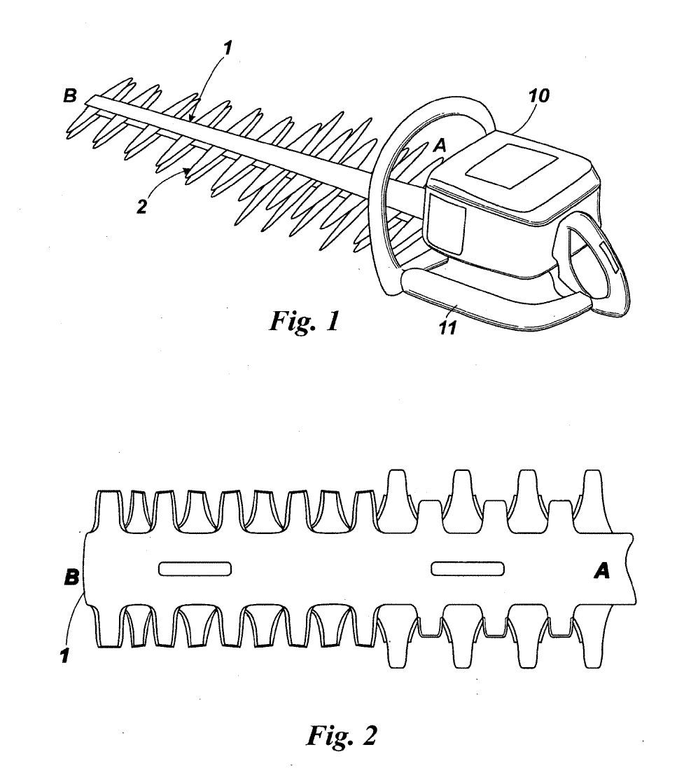

FIG. 1 shows an embodiment of a hedge trimmer which is within the scope of the second aspect of the invention,

FIG. 2 shows in top view a portion of the first and second blades of the hedge trimmer of FIG. 1;

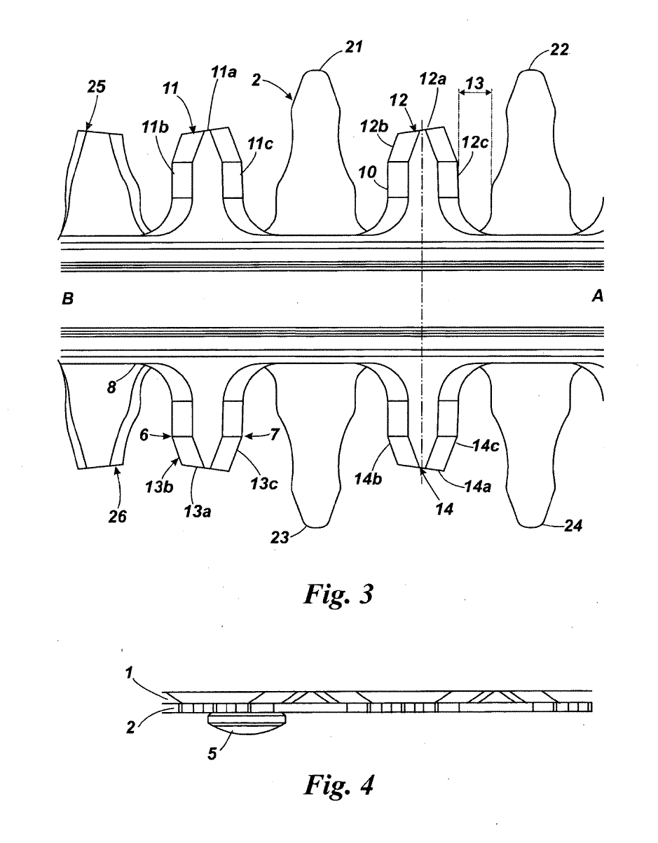

FIG. 3 shows a detail view similar to that of FIG. 2 of a portion of the first blade and second blade;

FIG. 4 is a detail view on edge of the same portion of the first and second blades shown in FIG. 3

FIG. 5 is a view corresponding to FIG. 3 of a portion of an alternative set of first and second blades which are provided in an alternative embodiment of a hedge trimmer in accordance with the present invention; and

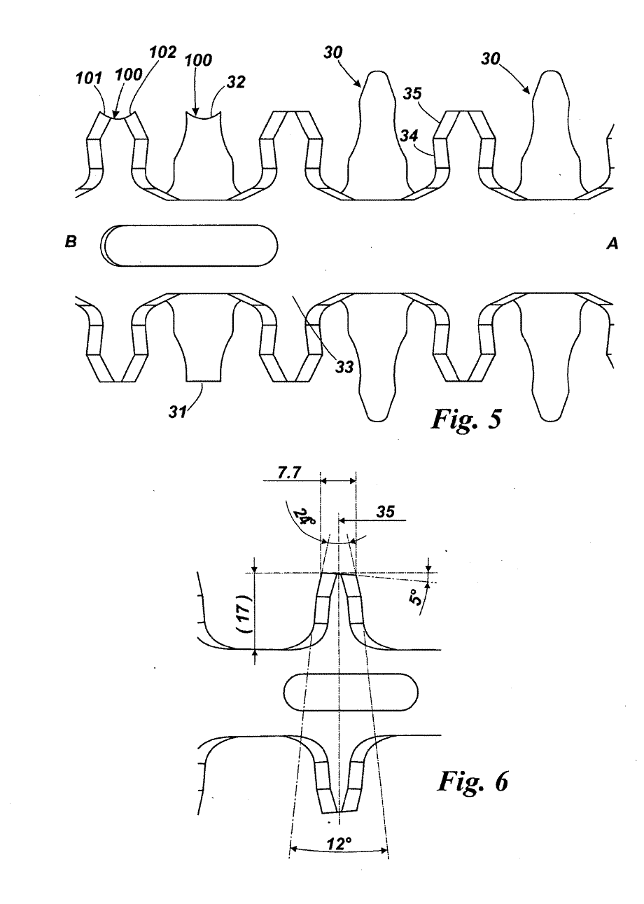

FIG. 6 shows in detail a single tooth of the first blade of the hedge trimmer of FIG. 1 marked with the angles of the flanks and connecting edge.

FIG. 1 illustrates a hedge trimmer 100 in accordance with the present invention. It comprises a main body 10 which includes a motor (not visible) and handle 11 attached to the main body 10 by which the trimmer can be carried by a user. Extending from the main body are two blades. A first, upper blade 1 is secured to the motor through a mechanism which causes the blade to reciprocate along the long axis of the blade as the motor rotates. The second, lower, blade 2, lies underneath the upper blade 1. In this embodiment the second blade 2 does not reciprocate, although it is to be understood that it is within the scope of the present invention that the lower blade could also reciprocate in which case it would move 180 degrees out of phase with the upper blade so that as the upper blade moves towards the main body the lower blade moves away.

Each blade 1,2 carries a row teeth spaced apart along each long edge, the teeth of each row being spaced apart by a distance that is greater than the width of each tooth. The relative reciprocation between the two blades is approximately equal to this spacing so that, in use, in a first position two adjacent teeth on the first blade overlap completely two corresponding adjacent teeth on the second blade, and in a second position a tooth on the first blade lies wholly in between two corresponding adjacent teeth of the lower blade. FIG. 1 shows the blades in the first position. The second position can be seen in FIG. 2 which is a detailed view of the two blades. This arrangement permits twigs or branches to enter the gaps between teeth in the first position and for the corresponding teeth of the first and second blades which are adjacent the twig to cut through the twig as they move to the second position. This cutting action and arrangement of teeth is well known in the art and so will not be explained further here. In the context of this application a tooth of the first blade which overlaps a tooth of the second blade when in the first position is considered to correspond to that tooth of the second blade.

The blades 1,2 slide over one another and are prevented from sliding perpendicularly to the driven direction by guide pins 5 which extend through holes in the blades. One such guide pin can be seen in FIG. 4 of the accompanying drawings.

FIG. 3 shows a small section from the length of the two cutting blades in side elevation, and FIG. 4 shows the same section in top elevation, looking along the plane of the two blades. The section of FIGS. 3 and 4 is taken roughly 400 mm from the unit body which provides drive for the blades and controls for the operator. The main body 10 is positioned further down the blade on the side labeled A. The tip of the blade furthest from the operator is on the side labeled B.

Towards the side labeled A all of the teeth of the second blade are longer than those of the first blade so they extend further from the central axis of the blades than the teeth of the first blade. They are around 50 percent longer than the corresponding teeth of the first blade. Four of these teeth 21,22,23,24 are shown in FIG. 3, two on each side of the second blade, and four corresponding teeth 11,12,13,14 of the first blade are shown. The free end portions of the four teeth 21,22,23,24 of the second blade are blunt on both flanks and function as guards. Up to this blunt free end the flanks of the teeth are sharpened to define cutting edges. The flanks 11b,11c, 12b,12c, 13b,13c, 14b and 14c of the corresponding teeth 11,12,13,14 are sharpened right to the free ends. The guards therefore prevent the reciprocating teeth 11,12,13,14 of the first blade coming into accidental contact with a solid object such as a brick or stone wall. Any such contact may result in damage to the first teeth which may cause them to wear prematurely.

It can also be seen that the teeth on the second blade 30 towards end B are substantially the same length as those of the first blade and rather than having a blunt free end they are sharpened along both edges all the way to the free end. The first teeth towards the end B also have sharpened cutting edges all the way to the free ends of their flanks. These teeth within the context of the application are so-called special teeth.

It can also be seen in FIGS. 1 to 3 that the sharpened edges of these special teeth are joined by connecting edges 11a,12a,13a, 14a which are slanted to improve cutting on larger branches. The connecting edge comprises a single straight edge which joins the two sharpened side edges of a tooth to form two points on the tip of each tooth which act as pressure points and can improving sawing through thicker branches. The connecting edges 11a, 12a, 13a, 14a are inclined at an angle of around 5 degrees relative to the long axis of the blade (and inclination of zero degrees meaning that the connecting edges would be parallel to the long axis).

Every tooth has a wide root 33 which reduces stress concentrations at the base of the tooth. High stress concentrations cause flaws to initiate under fatigue and cracks may grow in the blade material potentially resulting in a tooth breaking off the blade.

A further alternative form of special teeth, which may be provided in place of each of the special teeth of the trimmer of FIG. 1 or in place of one or more of the special teeth can be seen in FIG. 5 of the drawings. This figure shows the same part of the two blades as shown in FIG. 3 but for an alternative design of hedge trimmer.

The blades of the hedge trimmer of FIG. 5 are similar to those of the trimmer of FIGS. 1 to 4 in that they include special teeth 100 on the first blade that correspond with special teeth of the second blade towards end B, and longer teeth with blunt free ends on the second blade at end A. They differ in that the connecting edge portions of all of the special teeth 100 of the two blades are concave and comprise first and second connecting edge portions 101,102 which are each inclined at an angle of around 8 degrees in opposing directions, the first slanting towards the root of the tooth from left to right and the second from right to left. Also it can be seen that only the teeth on one side of the blade have this arrangement, the teeth on the other side having flat connecting edges which are parallel to the long axis of the blades.

1. A blade for a hedge trimmer comprising a plurality of cutting teeth, each tooth having a longitudinal axis extending laterally away from the long axis of the blade, each cutting tooth comprising a root and a tip and opposing sides extending between the root and the tip, wherein at least one of the cutting teeth comprises a special tooth which is sharpened along at least one flank to form a cutting edge which extends to the free end of the tooth, and further in which the tip of the tooth includes a connecting edge which extends from one flank of the tooth to the other and at least one part of which is inclined at an angle of between 4 degrees and 20 degrees relative to the long axis of the blade.

2. A blade according to claim 1 in which the special tooth is sharpened on both flanks to form respective cutting edges which extend to the tip of the tooth and the connecting edge is inclined from one flank to the other flank.

3. A blade according to claim 1 in which the connecting edge is so shaped as to be concave.

4. A blade according to claim 3 in which the connecting edge defines a V-shaped or U-shaped connecting edge, with a first edge portion inclined at an angle of between 4 degrees and 20 degrees relative to the long axis of the blade and extending from one flank of the tooth towards the centre line of the tooth, and a second edge portion extending from the other flank of the tooth towards the centre line of the tooth and oppositely inclined at an angle of between 4 degrees and 20 degrees relative to the long axis of the blade.

5. A blade according to claim 1 which further includes a plurality of said special teeth located at spaced locations along a length of the blade which, in use, is furthest from the handle of the hedge trimmer and which further includes a plurality of teeth located at spaced locations along a length of the blade which, in use, is closer to the handle which are not sharpened right to the end.

6. A blade according to claim 5 in which there are at least one, or two, or four teeth located at spaced locations between the special teeth and the handle, each of which is not a special tooth.

7. A blade according to claim 1 in which there are at least four special teeth.

8. A blade according to claim 1 which includes two rows of teeth, one row on each edge of the blade.

9. A blade according to claim 1 in which the special tooth narrows in width from its root toward its free end, and the cutting edge on the at least one flank is beveled so that it tapers inwards at a greater angle towards the free end than it does over a mid portion.

10. A blade according to claim 1 which includes special teeth on one edge only of the blade.

11. A blade according to claim 1 in which the connecting edge is inclined at an angle of 5 degrees.

12. A hedge trimmer comprising at least two blades, a first blade and a second blade, the first blade including teeth that each have a longitudinal axis extending laterally away from the long axis of the first blade, each tooth comprising a root and a tip and opposing sides extending between the root and the tip, wherein at least one of the teeth comprises a special tooth which is sharpened along at least one flank to form a cutting edge which extends to the free end of the tooth, and further in which the tip of the tooth includes a connecting edge which extends from one flank of the tooth to the other and at least one part of which is inclined at an angle of between 4 degrees and 20 degrees relative to the long axis of the blade, and in which the second blade comprises a plurality of cutting teeth which co-operate with the teeth of the first blade to provide a cutting action as the blades reciprocate relative to one another, each cutting tooth having a longitudinal axis extending laterally away from the long axis of the blade, each cutting tooth comprising a root and a tip and opposing sides extending between the root and the tip, and in which at least one of the cutting teeth of the second blade is longer from root to tip than a corresponding tooth of the first blade and is blunt along both flanks towards its tip, and at least one of the cutting teeth of the second blade comprises a special tooth being of substantially the same length as the corresponding special tooth of the first blade.

13. A hedge trimmer according to claim 12 in which the longer teeth of the second blade are at least 30 percent longer than the corresponding teeth of the first blade.

14. A hedge trimmer according to claim 12 in which the first blade is arranged to reciprocate along its long axis relative to the second blade which is fixed.

15. A hedge trimmer according to claim 12 in which the at least one of the cutting teeth of the second blade is substantially the same length as each corresponding tooth on the first blade and comprises a special tooth which is sharpened along at least one side to form a cutting edge which extends to the free end of the tooth, and further in which the tip of the tooth comprises an edge portion which is inclined at an angle of between 4 degrees and 20 degrees extending from one side edge of the tooth towards its central axis.

16. A hedge trimmer according to claim 12 15 in which the connecting end of a special tooth on the first blade is inclined in an opposed direction to the direction of inclination of the connecting edge of a corresponding tooth of the second blade.

17. A hedge trimmer comprising a first blade and a second blade, in which the first blade comprises a set of teeth of a first length arranged at spaced locations along the blade, and a second blade which overlaps the first blade and which includes a first set of teeth substantially of the same first length as the corresponding teeth of the first blade, and a second set of teeth of longer length which provide guard portions to the corresponding teeth of the first blade, the second set of teeth comprising teeth closer to the handle of the hedge trimmer than the first set of teeth which have blunt free ends and the first set of teeth being sharpened on at least one side up to the tip.
